(19) United States
(12) Patent Application Publication
(10) Pub. No.: US 2011/0156871 A1
(43) Pub. Date: Jun. 30, 2011

(54) FREQUENCY CALIBRATING

(75) Inventors: Chi-Fat CHAN, Hong Kong (CN); Kong Pang PUN, Hong Kong (CN); Ka Nang Alex LEUNG, Hong Kong (CN); Chui-Sing Oliver CHOY, Hong Kong (CN)

(73) Assignee: The Chinese University of Hong Kong, Shatin (CN)

(21) Appl. No.: 12/650,308

(22) Filed: Dec. 30, 2009

(51) Int. Cl. H04B 7/005

(52) U.S. Cl. 340/10.1

(57) ABSTRACT

Disclosed are a device and a method for calibrating a frequency of a transponder applicable to an RFID system. The device may comprises: a pulse generating unit configured to generate a sequence of pulses based on a PIE symbol sequence from an interrogator of the RFID system; a counting unit configured to count clock cycles of a clock signal based on the generated pulses, wherein the transponder operates based on the clock signal; and a calibrating unit configured to calibrate a frequency of the clock signal towards a target frequency based on a comparison of the counted number of clock cycles with a reference number associated with the target frequency.

### TECHNICAL FIELD

The disclosure herein relates to frequency calibration, particularly to a device and a method for calibrating frequency of a transponder applicable to an RFID system.

### BACKGROUND

The known passive Ultra High Frequency (UHF) far-field Radio Frequency Identification (RFID) technology provides a wide communication range and a high data rate in an RFID system, which adopts EPC Class-1 Generation-2 (EPC C1G2) standard.

As is well known in the art, a typical RFID system comprises an interrogator (e.g., a reader) and a transponder (e.g., a tag). According to the standard, the communication between the transponder and the interrogator starts from the interrogator sending data to the transponder during the downlink period. Then the transponder will respond by backscattering data to the interrogator during the uplink period.

FIG. 1 shows data in a PIE (Pulse Interval Encoding) symbols format according to the EPC C1G2 standard, in which the downlink period comprises a preamble and a data chain. The preamble includes symbols such as a delimiter with a time length of 12.5 μs+/−5%, a data-0 with a time length of Tari, a RTcal with a time length of (1+x)Tari, and a TRcal. The data chain includes a sequence consisting of data-0 and data-1, such as “011 . . . ”. In the standard, the data-0 and data-1 may be determined by using a time length T_{RTcal} of RTcal. In particular, if a time length of a received PIE symbol is shorter than T_{RTcal}/2, it is data-0 and vice versa.

Each of the above symbols is represented by a rectangular pulse. According to the standard, the time length Tari of a data-0 may be selected from 6.25 μs, 12.5 μs, and 25 μs depending on applications. The time length of data-1 is (1+x) Tari, where x ranges from 0.5 to 1.

Upon receiving data from the interrogator, the transponder will respond thereto at a frequency recognizable to the interrogator so as to realize the communication therebetween. Generally, the frequency is generated by a frequency generator such as an oscillator in the transponder. In RFID applications, the frequency usually has a very low tolerance, for example, as low as ±4%. However, as environmental conditions such as the supply voltage and the temperature of the frequency generator vary with time, it is difficult to keep the frequency within the tolerance.

### SUMMARY OF CERTAIN INVENTION ASPECTS

According to one aspect of the application, a device for calibrating a frequency of a transponder applicable to an RFID system may comprise:

a pulse generating unit configured to generate a sequence of pulses based on a PIE symbol sequence from an interrogator of the RFID system;

a counting unit configured to count clock cycles of a clock signal based on the generated pulses, wherein the transponder operates based on the clock signal; and

a calibrating unit configured to calibrate a frequency of the clock signal towards a target frequency based on a comparison of the counted number of clock cycles with a reference number associated with the target frequency.

According to another aspect of the present application, a method for calibrating a frequency of a transponder applicable to an RFID system may comprise:

generating a sequence of pulses based on a PIE symbol sequence from an interrogator of the RFID system;

counting clock cycles of a clock signal based on the generated pulses, wherein the transponder operates based on the clock signal; and calibrating a frequency of the clock signal towards a target frequency based on a comparison of the counted number of clock cycles with a reference number associated with the target frequency.

### BRIEF DESCRIPTION OF THE DRAWINGS

FIG. 1 illustrates a PIE symbol format in the EPC C1G2 standard.

FIG. 2 illustrates an example of a device for calibrating a frequency of a transponder applicable to an RFID system according to one embodiment of the present application.

FIG. 3 illustrates a relationship of the pulses generated by the pulse generating unit as shown in FIG. 2 and the PIE symbols.

FIG. 4 illustrates an example of the inputs and outputs of the counting unit as shown in FIG. 2.

FIG. 5 illustrates deviation from the reference number.

FIG. 6 illustrates an example of the processing of the calibrating unit according to one embodiment of the present application.

FIG. 7 illustrates a flowchart of the processing for calibrating a frequency of a transponder applicable to an RFID system according to another embodiment of the present application.

### DETAILED DESCRIPTION OF CERTAIN INVENTIVE EMBODIMENTS

Embodiments of the present application will be described with reference to the accompanying drawings, but these drawings are presented only for the illustrative purpose and in no respect, are intended to limit the present application.

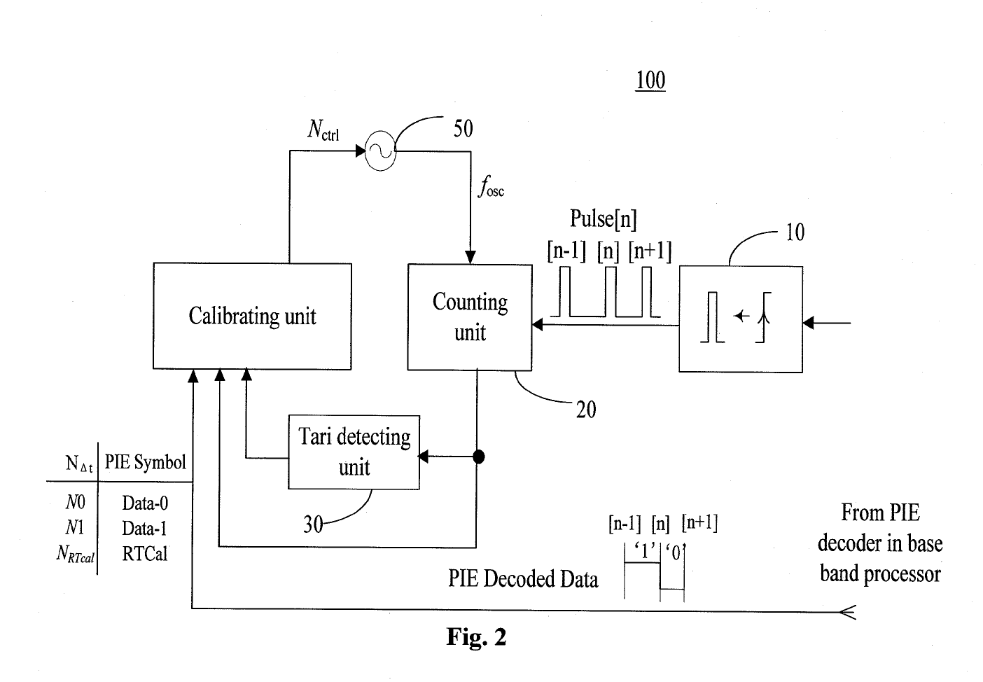

FIG. 2 shows a device 100 for calibrating a frequency of a transponder in an RFID system according to one embodiment of the present application. The device comprises a pulse generating unit 10, a counting unit 20, a Tari detecting unit 30, a calibrating unit 40 and a frequency generator 50.

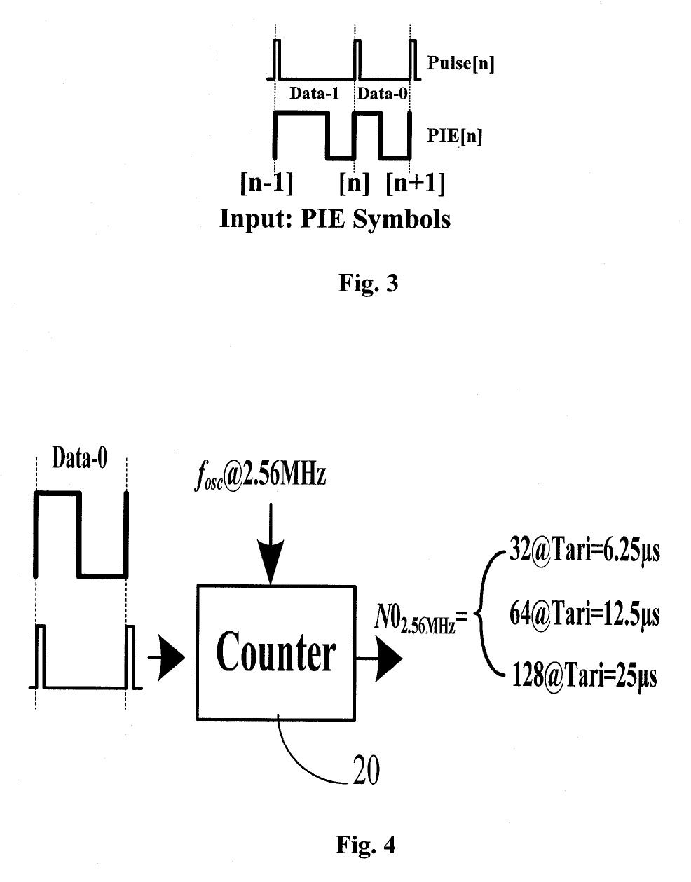

Specifically, the pulse generating unit 10 operates to receive data in the PIE symbols format from an interrogator (not shown) and generate a sequence of pulses, each of which is corresponding to each rising edge of rectangular pulses in PIE format of the received data, as shown in FIG. 3. The reference sign 301 represents the rectangular pulses in PIE format and 302 represents the pulses generated by unit 10.

The counting unit 20 is configured to receive a clock signal from the frequency generator 50. The generator 50 may be a number-controlled oscillator or the like. The pulses generated by the pulse generating unit 10 is fed to the counting unit 20 to inform the counting unit 20 to count the number of clock cycles of the clock signal of the generator 50 during a time period between each two adjacent pluses generated by the pulse generating unit 10 and the counted number will be subsequently sent to the calibration unit 40.

As stated above, upon receiving data from the interrogator, the transponder should respond at a frequency recognizable to the interrogator. T his frequency is usually referred as a “target frequency”. In this embodiment, if the transponder works at the target frequency, e.g., 2.56 MHz, the number of clock cycles between two rising edges of pulses 41 and 42, namely, duration of data-0, would be 32, 64, or 128 in a condition that Tari is 6.25 μs, 12.5 μs, or 25 μs, respectively. As a matter of fact, Tari has been standardized according to the known EPC C1G2 standard. The number of clock cycles of each duration of the standard symbols is referred as a reference number Nref. In this embodiment, the reference number is 32, 64, or 128 in a condition that Tari is 6.25 μs, 12.5 μs, or 25 μs at the target frequency of 2.56 MHz (See FIG. 4).

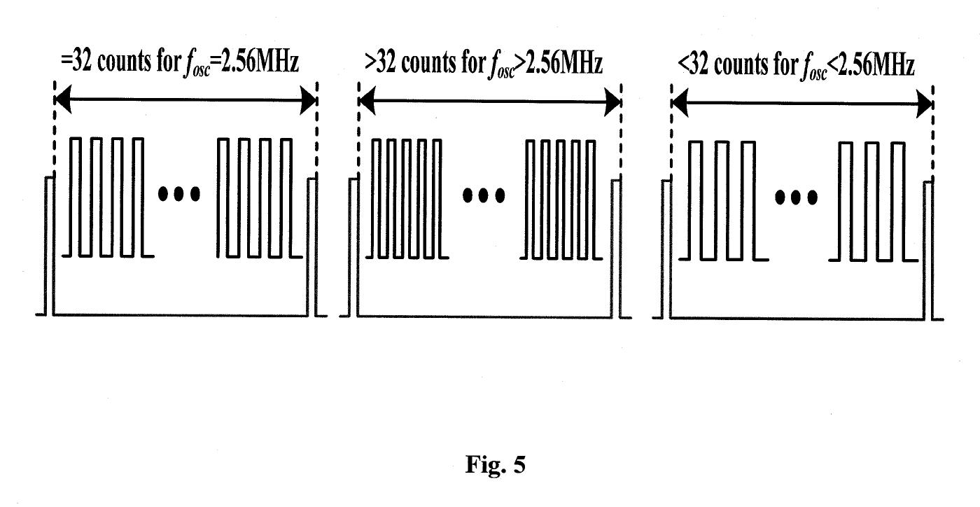

However, due to changes of environmental conditions, such as the supply voltage and the temperature, the frequency of the transponder may vary to deviate from the target frequency. Under the circumstances, the number of clock cycles during two rising edges of adjacent pulses will deviate from the corresponding reference number. As shown in FIG. 5, given that Tari is 6.25 μs, once the frequency becomes lower than 2.56 MHz, the number will be less than 32; and if the frequency is higher than 2.56 MHz, the number will be higher than 32. Hereafter, the number counted at the frequency deviated from the target frequency is refereed to as a counted number N.

In other words, when the counted number N deviating from a reference number, the frequency of the transponder shall be calibrated.

Since data-0 and data-1 in the data sequence have different time lengths, the reference numbers for data-0 and data-1 should also be different. Hereinafter, the counted numbers in data-0 duration and data-1 duration are denoted as N0 and N1, respectively. In the case that a target frequency is 2.56 MHz as shown in FIGS. 2 and 4, the reference numbers for data-0 duration and data-1 duration are denoted as N0_{2.56MHz} and N1_{2.56MHz}, respectively. The following description will be given in reference to the target frequency 2.56 MHz.

The reference numbers may be determined based on the pre-determined target frequency such as 2.56 MHz and the Tari which can be determined by the Tari detector 30 based on the preamble received from the interrogator. The Tari detector 30 is used to detect the values Tari in-use at the beginning of an inventory round. At the beginning of an inventory round, once the preamble is received, the counted number N0 is obtained in the counting unit 20 by counting the number of clock cycles of the clock signal generated by the frequency generator 50 between the first two sharp pulses generated by the pulse generating unit 10, i.e., the data-0 duration in the preamble. The counted number N0 is inputted into the Tari detector 30 so that an estimate value of Tari is calculated based on the inputted N0 and the predetermined target frequency.

As mentioned in the above, the reference number for data-0 is corresponding to the value of Tari, so the calibrating unit 40 may easily determine which number out of 32, 64, and 128 will be used as the reference number N0_{2.56MHz} based on the detected Tari.

Then, the reference number N1_{2.56MHz} will be determined by the calibrating unit 40 based on counted numbers N0 and N_{RTcal} as well as the determined N0_{2.56MHz} as below, where the counted number N_{RTcal} represents the number of clock cycles counted in the RTcal duration in the PIE preamble.

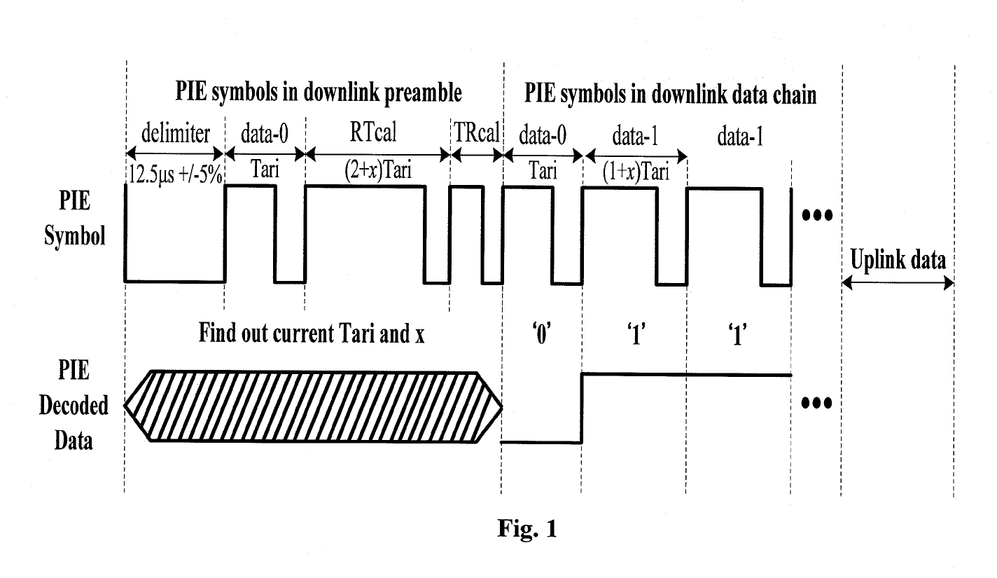

Referring to FIG. 1 again, in the EPC C1G2 standard, the time length of RTcal in the PIE preamble T_{RTcal} is described as

T_{RTcal}=(2+x)×Tari

Meanwhile, the following formulas are obtained:

time length of data-0 T_{data-0}=Tari

time length of data-1 T_{data-1}=(1+x)×Tari

Thus, T_{data-1}=T_{RTcal}-T_{data-0}, where T_{RTcal} and T_{data-0} are obtained under the frequency generated at the beginning of the inventory round, which may be deviated from the target frequency. Based on the formula T_{data-1}=T_{RTcal}−T_{data-0}, it can be obtained that N1=N_{RTCAL}−N0.

However, since the counted number N_{RTCAL} and N0 are counted with the frequency being un-calibrated, the result number from the subtracting operation cannot be used as reference number for data-1 directly. According to the one embodiment of the application, the calibrator 40 operates to determine the reference number N1_{2.56MHz} by rule of:

$$N {1}_{2.56 MHz} = ( \frac{{N}_{RTcal} - N 0}{N 0} ) \cdot N {0}_{2.56 MHz} \qquad Eq . 1$$

Once reference numbers for both data-0 and data-1, such as N0_{2.56MHz} and N1_{2.56MHz}, are determined, the calibrating unit 40 operates to selectively use the reference number for data-0 such as NO_{2.56MHz} or the reference number for data-1 such as N1_{2.56}MHz in the subsequent calibrating based on the received data-0 or data-1. A well-known baseband processor (not shown) in the transponder is capable of distinguishing data-0 and data-1 and then informs the calibrating unit 40 to select N0_{2.56MHZ} for data-0 and to select N1_{2.56MHz} for data-1 to perform the calibration. The calibration proceeds until the beginning of backscattering communication. Since the calibration is performed in the transponder during a downlink period, i.e., when downlink data is transmitted from the interrogator from the transponder, no communication time is wasted.

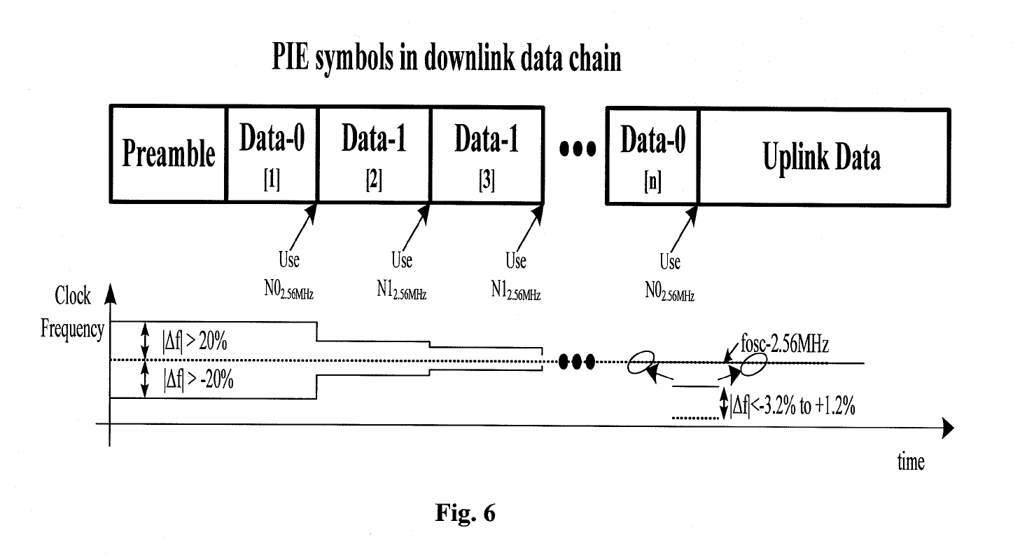

FIG. 6 illustrates the processing of the calibration according to one embodiment of the application. The curves 601 and 602 represent the calibration for frequencies higher and lower than a target frequency by more than 20%. The target frequency is represented by a dotted line. As stated above, the reference numbers for both data-0 and data-1 are obtained. Thus, when each symbol in the data sequence following the preamble is received, the number of clock cycles for the generator 50 during the symbol duration is counted. It is also determined whether the data symbol is data-0 or data-1 as stated above. Thus, one of the reference numbers can be selected to compare with the counted number. The frequency is then calibrated according to the comparison after each symbol is received until the downlink communication ends and the uplink data begins to be transmitted from the transponder. As shown in FIG. 6, the frequency with an initial deviation of more than 20% is calibrated to have a deviation in the range from −3.2% to +1.2%, which falls in the frequency tolerance.

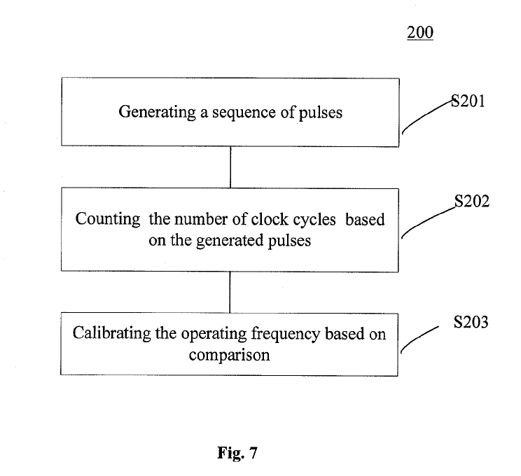

Hereinabove, the device according to one aspect of the application has been discussed. A process 200 for calibrating a frequency of a transponder in a RFID system according to another aspect of the application will be discussed in reference to FIG. 7.

As shown in FIG. 7, the process 200 begins with step S201, in which a sharp pulse signal is generated based on a PIE symbol sequence from the interrogator in the RFID system, as mentioned in the above. At step S202, the number of clock cycles of a clock signal for the transponder is counted in a downlink data duration based on the generated pulses. In particular, the number of clock cycles of the clock signal for the transponder is counted during a time between each two adjacent generated sharp pluses.

Then, at step S203, a frequency of the clock signal is calibrated based on a comparison of the counted number with a reference number. In particular, the counted number is compared with a first reference number such as N0_{2.56MHz} when receiving the data-0 in the PIE symbol sequence, or compared with a second reference such as N1_{2.56MHz} when receiving the data-1 in the PIE symbol sequence, so as to calibrate the frequency based on the comparison. The frequency will be tuned high when the counted number is less than a selected reference number, while the frequency is to be tuned low when the counted number is more than the selected reference number. Since the calculation of the reference numbers have been discussed above, the description thereof is omitted herein. In addition, the generating, counting and calibrating described in steps S201, S202 and S203, respectively, may be processed with the above mentioned pulse generating unit 10, counting unit 20 and calibrating unit 40 in the same way as discussed above.

Though some particular embodiments and implementations of the application have been shown and described above for illustrative purposes, it should be apparent that other embodiments and implementations can be made for those skilled in the art in accordance with the disclosure herein, which should be within the scope of the following claims.

1. A device for calibrating a frequency of a transponder applicable to an RFID system, comprising:
a pulse generating unit configured to generate a sequence of pulses based on a PIE symbol sequence from an interrogator of the RFID system;
a counting unit configured to count clock cycles of a clock signal based on the generated pulses, wherein the transponder operates based on the clock signal; and
a calibrating unit configured to calibrate a frequency of the clock signal towards a target frequency based on a comparison of the counted number of clock cycles with a reference number associated with the target frequency.

2. The device of claim 1, wherein the counting unit is further configured to count clock cycles of the clock signal when the interrogator sends data to the transponder.

3. The device of claim 2, wherein the counting unit is further configured to count clock cycles of the clock signal during a time between each two adjacent pluses in the generated pulses.

4. The device of claim 1, wherein the reference number comprises a first reference number or a second reference number, and
wherein the calibrating unit is further configured to selectively compare the counted number with the first reference number or the second reference number so as to calibrate the frequency based on the comparison.

5. The device of claim 4, wherein the PIE symbol sequence comprises a preamble with a data-0, and a data chain with a plurality of data-0 and data-1;
wherein the calibrating unit is further configured to determine the first reference number based on a value of a Tari in the preamble according to the EPC C1G2 standard and the target frequency, and determine the second reference number based on the first reference number.

6. The device of claim 5, wherein the second reference number is determined based on the first reference number by rule of
$${N}_{ref 1} = ( \frac{{N}_{RTcal} - N 0}{N 0} ) \cdot {N}_{ref 0}$$
where N_{ref1} represents the second reference number, N_{ref0} represents the first reference number, N_{RTcal} represents a time length of RTcal in the preamble according to the EPC C1G2 standard, and N0 represents the first number of the counted numbers.

7. The device of claim 5, wherein the calibrating unit is further configured to compare the counted number with the first reference number when receiving the data-0 in the data chain, and with the second reference number when receiving the data-1 in the data chain, so as to calibrate the frequency based on the comparison.

8. The device of claim 1, wherein the clock signal is output from a frequency generator that is arranged in the device.

9. The device of claim 1, wherein the clock signal is output from a frequency generator that is arranged outside the device.

10. A method for calibrating a frequency of a transponder applicable to an RFID system, comprising:
generating a sequence of pulses based on a PIE symbol sequence from an interrogator of the RFID system;
counting clock cycles of a clock signal based on the generated pulses, wherein the transponder operates based on the clock signal; and
calibrating a frequency of the clock signal towards a target frequency based on a comparison of the counted number of clock cycles with a reference number associated with the target frequency.

11. The method of claim 10, wherein the counting further comprises:
counting the clock cycles of the clock signal when the interrogator sends data to the transponder based on the generated pulses.

12. The method of claim 11, wherein the counting further comprises:
counting the clock cycles of the clock signal during a time between each two adjacent pluses in the generated pulses.

13. The method of claim 10, wherein the reference number comprises a first reference number or a second reference number, and
wherein the calibrating further comprises: comparing selectively the counted number of clock cycles with the first reference number or the second reference number so as to calibrate the frequency based on the comparison.

14. The method of claim 13, wherein the PIE symbol sequence comprises a preamble with a data-0, and a data chain with a plurality of data-0 and data-1;
wherein the first reference number is determined based on a value of a Tari in the preamble according to the EPC C1G2 standard and the target frequency; and
wherein the second reference number is determined based on the first reference number.

15. The method of claim 14, wherein the second reference number is determined based on the first reference number by rule of
$${N}_{ref 1} = ( \frac{{N}_{RTcal} - N 0}{N 0} ) \cdot {N}_{ref 0}$$
where N_{ref1} represents the second reference number, N_{ref0} represents the first reference number, N_{RTcal} represents a time length of RTcal in the preamble according to the EPC C1G2 standard, and N0 represents the first number of the counted numbers.

16. The method of claim 14, wherein the calibrating further comprises:
comparing the counted number of clock cycles with the first reference number when receiving the data-0 in the data chain, or
comparing the counted number of clock cycles with the second reference number when receiving the data-1 in the data chain; and
calibrating the frequency based on the comparison.

17. A transponder comprising:
a pulse generating unit configured to generate a sequence of pulses based on a PIE symbol sequence from an interrogator of the RFID system;
a counting unit configured to count clock cycles of a clock signal based on the generated pulses, wherein the transponder operates based on the clock signal; and
a calibrating unit configured to calibrate a frequency of the clock signal towards a target frequency based on a comparison of the counted number of clock cycles with a reference number associated with the target frequency.
